(19) United States
(12) Patent Application Publication
(10) Pub. No.: US 2015/0194018 A1
(43) Pub. Date: Jul. 9, 2015

(54) Casino Offer Network and Method of Operation

(71) Applicant: Andy Choy, Las Vegas, NV (US)

(72) Inventor: Andy Choy, Las Vegas, NV (US)

(21) Appl. No.: 14/151,429

(22) Filed: Jan. 9, 2014

(51) Int. Cl. G07F 17/32

(52) U.S. Cl. CPC G07F 17/3255

(57) ABSTRACT

A system includes a memory and one or more processors. The memory is operable to store (a) one or more primary offers associated with a first entity, each primary offer associated with a primary offer value; (b) a first secondary offer associated with a second entity, the first secondary offer associated with a first secondary offer value; and (c) a second secondary offer associated with the second entity, the second secondary offer associated with a second secondary offer value. The one or more processors are operable to (a) compare the first secondary offer value and the second secondary offer value with the primary offer values of the one or more primary offers; (b) identify at least one of the first secondary offer and the second secondary offer based at least in part on the comparison; and (c) communicate the identified secondary offer to a user device.

### TECHNICAL FIELD

This disclosure relates generally to loyalty rewards programs and more specifically to a casino offer network and method of operation.

### BACKGROUND

Traditionally, a casino may provide one or more offers (e.g., a free night of stay at the casino) to the casino's loyalty program members as a reward to the members for remaining loyal to the casino and further to entice the members to continue playing games at the casino (as opposed to another casino). These offers may be based on a member's status at the casino. For example, based on an amount of time and/or amount of money spent by a particular member (e.g., Player 1) gaming in the casino, Player 1 may have a particular status with the casino (e.g., a bronze membership status, a silver membership status, a gold membership status, a platinum membership status, or any other type of status offered by the casino). The status of Player 1 may affect the type of offer Player 1 receives from the casino. For example, in order to entice an individual with a bronze membership status to keep gaming in the casino, the casino may offer a free dinner to that individual. On the other hand, in order to entice an individual with a platinum member status, the casino may offer the individual a free night of stay in a suite of the casino. Each of these offers by the casino may be personalized offers that are meant to entice an individual with a particular status at the casino to keep gaming at the casino.

Unfortunately, such personalized offers from a casino (e.g., offers that are based on an individual's status at the casino) can traditionally only be offered to individuals who are loyalty program members of the casino. As such, traditional methods of providing offers to entice an individual to play games at a casino may be deficient.

### SUMMARY OF THE DISCLOSURE

According to one embodiment, a Casino 2 may be able to provide one or more secondary offers to a user who is a loyalty program member of Casino 1. Both Casino 1 and Casino 2 may communicate with a third-party intermediary in order to provide these offers to the users.

As an example, Casino 1 may communicate with the third-party intermediary in order to provide primary offers to a customer that is a loyalty program member of Casino 1 (such as Player 1). The primary offers may include a free night of stay at Casino 1 and/or a free ticket to a concert. Furthermore, to entice Player 1 to play games at Casino 2, Casino 2 may also communicate with the third-party intermediary in order to provide secondary offers to Player 1. The secondary offers may include, for example, a free night of stay at Casino 2, a free dinner, and/or $100 in player chips at Casino 2. The third party intermediary may provide one or more of these secondary offers to Player 1 based on the program status of Player 1 at Casino 1. For example, the third party intermediary may utilize the value of one or more primary offers sent by Casino 1 to Player 1 in order to determine which secondary offer from Casino 2 to provide to Player 1. Furthermore, the primary offers from Casino 1 and the secondary offers from Casino 2 may be communicated to a smart phone application being executed on Player 1's smart phone. The smart phone application may be an application that is provided by, or otherwise associated with, Casino 1.

Certain embodiments of the disclosure may provide one or more technical advantages. For example, by providing a secondary offer associated with Casino 2 based at least in part on a primary offer associated with Casino 1, the secondary offer may be triggered by the primary offer as identified based on the value of one or more primary offers. As such, the secondary offer may be provided to a user without Casino 2 receiving identifying information for the customer and/or without Casino 2 receiving information about the status of the customer at Casino 1. Yet, the system of the present disclosure facilitates Casino 2 to make secondary offers to customers of Casino 1 which may entice that customer to try Casino 2. Furthermore, Casino 1 may set one or more restriction settings in order to prevent one or more other casinos from providing offers to Casino 1's customers. As such, Casino 1 may be able to prevent other casinos in the same market (and/or who are competitors with Casino 1) from providing offers to Casino 1's customers.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an example of a casino offer network system;

FIG. 2 illustrates examples of primary offers associated with a first entity and secondary offers associated with a second entity; and

FIG. 3 illustrates an example of a method associated with the casino offer network system of FIG. 1.

### DETAILED DESCRIPTION OF THE DRAWINGS

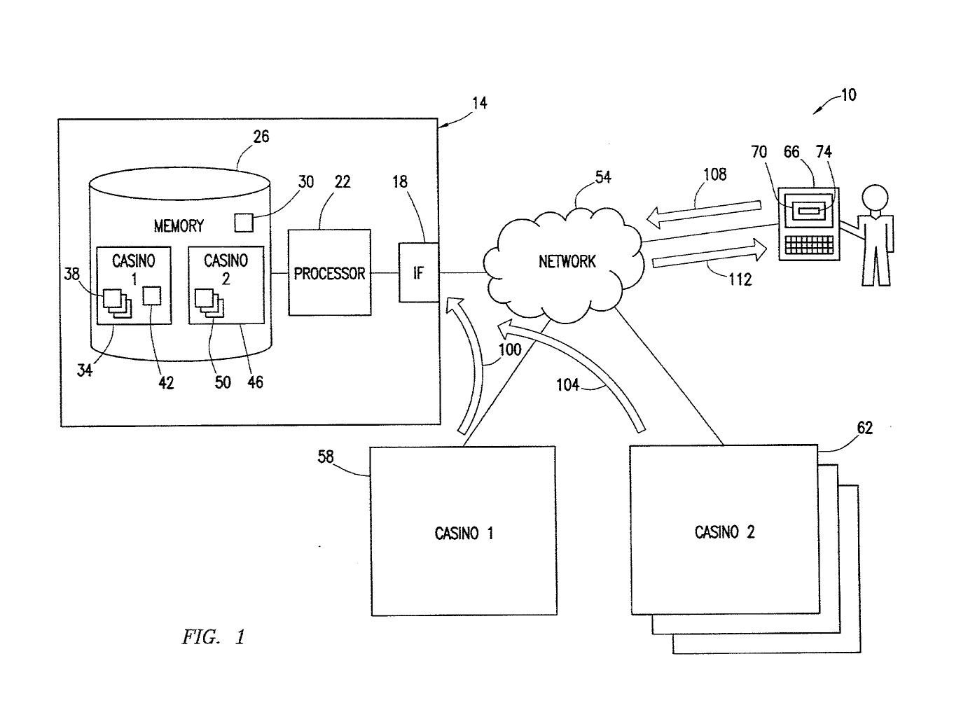

Embodiments of the present disclosure are best understood by referring to FIGS. 1 through 3 of the drawings, like numerals being used for like and corresponding parts of the various drawings.

A casino (such as Casino 1) may traditionally provide games (or other services) that may allow an individual to wager an amount of money for the chance to win additional money. When an individual (such as Player 1) periodically plays games at Casino 1, Player 1 may join Casino 1's loyalty program in order to receive one or more benefits from Casino 1. Such benefits may include offers from Casino 1 (such as an offer for a free night of stay at Casino 1). These offers may reward Player 1 for remaining loyal to Casino 1 and may further be used by Casino 1 to entice Player 1 to continue playing games at Casino 1, as opposed to another casino.

Many of the offers provided by Casino 1 may be based on Player 1's status with Casino 1. For example, based on an amount of time and/or amount of money spent by Player 1 in Casino 1, Player 1 may have a particular status with Casino 1 (e.g., a bronze membership status, a silver membership status, a gold membership status, a platinum membership status, or any other type of status offered by Casino 1). The status of Player 1 at Casino 1 may affect the type of offers Player 1 receives from Casino 1. For example, in order to entice an individual with a bronze membership status to continue gaming in Casino 1, Casino 1 may offer a free dinner to that individual. On the other hand, in order to entice an individual with a platinum member status to continue gaming in Casino 1, Casino 1 may offer the individual a free night of stay in a suite of Casino 1. Each of these offers by Casino 1 may be personalized offers that are meant to entice an individual with a particular status at Casino 1 to keep gaming at Casino 1.

Unfortunately, such personalized offers from Casino 1 (e.g., offers that are based on an individual's status at Casino 1) can traditionally only be offered to individuals who are loyalty program members of Casino 1. One reason for this is that Casino 1 may not have any information about other individuals who are not loyalty program members of Casino 1. As such, even if an individual has a platinum membership status at another casino (such as Casino 2), Casino 1 may not know this, and therefore, may be unable to provide offers to this individual in order to entice the individual to game at Casino 1, instead of Casino 2. Additionally, even if Casino 1 was able to contact a loyalty program member of Casino 2 (e.g., by using mass mailing promotions), the offer may not be enough to entice the loyalty program member to game at Casino 1. For example, if the loyalty program member typically receives a free night of stay in a suite at Casino 2 as enticement to continue playing games in Casino 2, a mass mailing offer from Casino 1 for a free dinner may not entice the loyalty program member to game at Casino 1.

One traditional attempt to solve one or more of these disadvantages involves an agreement between Casino 1 and Casino 2 to share information about each other's loyalty program members. Unfortunately, such an agreement may be undesirable because it involves both Casino 1 and Casino 2 sharing identifying information (e.g., names, contact information, etc.) and status information for each loyalty program member. Casino 1 may not desire to provide this identifying information and/or status information to Casino 2 because it may allow Casino 2 to steal Casino 1's loyalty program members. In one embodiment, however, the sharing of information among Casinos may be acceptable.

In particular embodiments, system 10 of FIG. 1 may address one or more of the above disadvantages. System 10 establishes an offer network whereby entities, such as casinos as described in this example, may subscribe so that they may be able to provide offers to program members of other casinos in an effective manner. Although this description is detailed with respect to gaming entities, such as casinos, one of skill in the art would understand that the concept of an offer network as described in this disclosure extends to any suitable type of entity in any suitable industry. For example, it may extend to entities in the retail industry (e.g., online and brick and mortar retailers, etc.), hospitality industry (e.g., hotels, restaurants, bars, etc.), services industry, entertainment industry (e.g., sports, theater, music, etc.), transportation industry (e.g., airlines, car rentals, trains, etc.), financial industry (e.g., banks, brokerages, lending agencies, etc.).

According to one embodiment as described in the gaming industry, Casino 1 and Casino 2 may subscribe to a casino offer network system 10. Casino 2 (which may be referred to as second gaming entity 62) provides one or more secondary offers (which may be referred to as secondary offers 50) to a customer who is a loyalty program member of Casino 1 (which may be referred to as first gaming entity 58). As is illustrated in FIG. 1, both Casino 1 and Casino 2 may communicate with a third-party intermediary (which may be referred to as device 14) in order to provide these offers to the users. As an example, Casino 1 may communicate with the third-party intermediary in order to provide primary offers (which may be referred to as primary offers 38) to a customer that is a loyalty program member of Casino 1 (such as Player 1). For example, the primary offers may include a free night of stay at Casino 1 and/or a free ticket to a concert. Furthermore, to entice Player 1 to play games at Casino 2, Casino 2 may also communicate with the third-party intermediary in order to provide secondary offers 50 to Player 1. For example, the secondary offers 50 may include a free night of stay at Casino 2, a free dinner, and/or $100 in player chips at Casino 2.

Based on the communications with Casino 1 and Casino 2, the third party intermediary may provide one or more of these secondary offers to Player 1. For example, the third party intermediary may utilize a primary offer 38 from Casino 1 in order to determine which secondary offer 50 from Casino 2 should be provided to Player 1. The third party intermediary may make this determination based on the value of one or more primary offers 38 from Casino 1 to Player 1, because neither Casino 2 nor the third party intermediary may know the status of Player 1 at Casino 1 (or any identifying information for Player 1).

Thus, the third party intermediary may store one or more primary offers 38 offered to Player 1 by Casino 1 within a predetermined period of time (e.g., within last day, week, month, year, etc.). Each of these primary offers 38 may be associated with a primary offer value. Casino 2 then communicates to third party intermediary a number of secondary offers 50 for consideration to send to Player 1. Each of the secondary offers 50 also is associated with a value. The third party intermediary then compares the values of the secondary offers 50 with the values of the primary offers 38 to identify the appropriate one or more secondary offers 50 to send to Player 1.

In a more detailed example, the third party intermediary may determine to provide Player 1 with a secondary offer 50 of: (1) a free night of stay at Casino 2 when Casino 1 has offered Player 1 a primary offer 38 with a value greater than $750; (2) a free dinner when Casino 1 has offered Player 1 a primary offer 38 with a value in-between $500 and $750; or (3) $100 in player chips when Casino 1 has offered Player 1 a primary offer 38 with a value in-between $200 and $499. As such, for example, when Casino 1 offers Player 1 a free night of stay with a value of $500, the third party intermediary may provide (on behalf of Casino 2) a secondary offer 50 to Player 1 for a free dinner (e.g., the value of the free night of stay at Casino 1 is worth $500, which falls in-between the range of $500-$750 that is associated with the free dinner of Casino 2). As a result, Casino 2 may be able to provide secondary offers 50 that are appealing to Player 1 without knowing the status or identify of Player 1 at Casino 1.

Furthermore, the secondary offer 50 provided by Casino 2 to Player 1 may also be based on the highest valued offer provided by Casino 1. For example, if Casino 1 provides a primary offer 38 with a value of $500 and another primary offer 38 with a value of $750, the secondary offer 50 provided by Casino 2 to Player 1 may be based on the $750 offer (as opposed to the $500 offer). As such, the secondary offer 50 provided by Casino 2 may be even more appealing to Player 1. In still other embodiments, the secondary offer 50 may be based on any suitable calculation based on one or more primary offer 38 to Player 1, including without limitation, an average of the primary offer 38 offered to Player 1 for a specific period of time, the highest value of primary offer 38 offered to Player 1 for a specific period of time, the median of the primary offer 38 offered to Player 1 over a specific period of time, or any other secondary offer 50 that is derived from one or more primary offer 38 offered to Player 1 over a specific period of time.

As is discussed above, the third party intermediary may provide one or more of the primary offers 38 and secondary offers 50 to Player 1. In doing so, the primary offers 38 and the secondary offers 50 may be communicated to a smart phone application (which may be referred to as application 70) being executed on Player 1's smart phone (which may be referred to as user device 66). The smart phone application may be an application that is provided by, or otherwise associated with, Casino 1. For example, after registering as a loyalty program member with Casino 1, Player 1 may be able to download the smart phone application to view primary offers 38 from Casino 1. Because in some embodiments only Casino 1 may have contact with Player 1, or may have identifying information for Player 1, the secondary offers 50 from Casino 2 may be communicated to Player 1 utilizing the smart phone application associated with Casino 1. As such, the same smart phone application may allow Player 1 to view primary offers 38 from Casino 1 and secondary offers 50 from Casino 2.

Player 1 may utilize the smart phone application in order to view any type of offers. For example, Player 1 may request to only view offers from Casino 1. As another example, if Player 1 is looking for an alternative to Casino 1 (e.g., they want to try their luck somewhere else for a little time), Player 1 may choose to be able to view secondary offers 50 from Casino 2. As a further example, when Player 1 is traveling to another state, Player 1 may choose to view only secondary offers 50 from a Casino 2 that is located in that state, as opposed to the state in which Casino 1 is located in. As such, not only may the smart phone application allow Casino 1 to provide its own primary offers 38 to Player 1, but the smart phone application may also allow Casino 1 to provide Player 1 with the ability to view offers from other casinos (such as Casino 2) that Player 1 may want to take advantage of.

Furthermore, Casino 1 may also be able to prevent Player 1 from receiving (and/or viewing) offers from other casinos. For example, Casino 2 may be a direct competitor of Casino 1 (e.g., both Casino 1 and Casino 2 may be located within 5 miles from each other and compete for the same customers). In order to prevent Casino 2 from providing offers to Player 1, Casino 1 may communicate restriction settings (which may be referred to as restriction settings 42) to the third party intermediary. These restriction settings 42 may restrict which casinos may and/or may not provide secondary offers 50 to Player 1. For example, in order to prevent Casino 2 (which in this example is a direct competitor located 5 miles from Casino 1) from stealing the customers of Casino 1, Casino 1 may communicate a restriction setting 42 that prevents any casino located within 50 miles of Casino 1 from being able to provide secondary offers 50 to Player 1. Based on this restriction setting, the third party intermediary may prevent secondary offers 50 from Casino 2 from being provided to Player 1.

Although one embodiment of system 10 of FIG. 1 has been discussed above, system 10 may include additional embodiments and functionalities, as is discussed below. As illustrated, system 10 of FIG. 1 includes device 14, network 54, first gaming entity 58, second gaming entities 62, and user device 66.

Device 14 represents any components that provide (or otherwise communicate) a secondary offer 50 associated with a second gaming entity 62 to a user based at least in part upon primary offers 38. The third party intermediary discussed above may be one example of device 14 and/or one example of an entity that may utilize device 14. Device 14 may include a network server, any remote server, a mainframe, a host computer, a workstation, a web server, a file server, a personal computer, a work station, a laptop, a wireless or cellular telephone, an electronic notebook, a personal digital assistant, one or more processors and memories, or any other device that stores information for primary offers 38, secondary offers 50, and communicates an appropriate secondary offer 50 based one or more primary offers 38 to a user device 66.

The functions of device 14 may be performed by any combination of one or more servers or other components at one or more locations. In the embodiment where the module is a server, the server may be a private server, and the server may be a virtual or physical server. The server may include one or more servers at the same or remote locations. Also, device 14 may include any component that functions as a server. In the illustrated embodiment, device 14 includes a network interface 18, a processor 22, and a memory 26.

Network interface 18 represents any device operable to receive information from network 54, transmit information through network 54, perform processing of information, communicate to other devices, or any combination of the preceding. For example, network interface 18 receives one or more primary offers 38 from a first gaming entity 58, and further receives one or more secondary offers 50 from a second gaming entity 62. As another example, network interface 18 communicates at least one of the secondary offers 50 to a user device 66. Network interface 18 represents any port or connection, real or virtual, including any suitable hardware and/or software, including protocol conversion and data processing capabilities, to communicate through a local area network (LAN), a metropolitan area network (MAN), a wide area network (WAN), or other communication system that allows device 14 to exchange information with network 54, first gaming entity 58, second gaming entities 62, user device 66, or other components of system 10.

Processor 22 communicatively couples to network interface 18 and memory 26, and controls the operation and administration of device 14 by processing information received from network interface 18 and memory 26. Processor 22 includes any hardware and/or software that operates to control and process information. For example, processor 22 executes device management application 30 to control the operation of device 14. Processor 22 may be a programmable logic device, a microcontroller, a microprocessor, any processing device, or any combination of the preceding.

Memory 26 stores, either permanently or temporarily, data, operational software, or other information for processor 22. Memory 26 includes any one or a combination of volatile or non-volatile local or remote devices suitable for storing information. For example, memory 26 may include random access memory (RAM), read only memory (ROM), magnetic storage devices, optical storage devices, or any other information storage device or a combination of these devices. While illustrated as including particular modules, memory 26 may include any information for use in the operation of device 14.

In the illustrated embodiment, memory 26 includes device management application 30, first gaming entity information 34, and second gaming entity information 46. Device management application 30 represents any suitable set of instructions, logic, or code embodied in a computer-readable storage medium and operable to facilitate the operation of device 14 as described herein.

First gaming entity information 34 represents any information associated with the first gaming entity 58. For example, as is illustrated, first gaming entity information 34 includes primary offers 38 and restriction settings 42. Primary offers 38 represent one or more offers associated with the first gaming entity 58. The primary offers of Casino 1 discussed above may be one example of primary offers 38.

A primary offer 38 may have a value associated with the primary offer 38. As an example, an offer for a free night of stay at the first gaming entity 58 may have a value of $500, a free ticket to a concert may have a value of $200, a free dinner may have a value of $150, and $100 in player chips at the first gaming entity 58 may have a value of $100. The value of a primary offer 38 may be determined in any suitable manner. For example, the value of the primary offer 38 may be provided to device 14 by the first gaming entity 58, an administrator associated with device 14, a third-party entity, or any combination of the preceding.

Memory 38 may store any number and combination of primary offers 38 for any number and combination of customers associated with any number and combination of gaming entities 58.

Restriction setting 42 represents any information that may provide one or more restrictions associated with an entity. The restriction settings discussed above may be one example of restriction settings 42. A first gaming entity 58 may want to prevent another gaming entity (such as a direct competitor) from providing offers to users associated with the first gaming entity 58. In order to prevent such offers, the first gaming entity 58 may provide (or otherwise be associated with) a restriction setting 42 that restricts other gaming entities from providing offers to the customers of first gaming entity 58.

A restriction setting 42 may include any suitable number, combination, and types of restrictions. As a first example, a restriction setting 42 may provide an entity-specific restriction. In such an example, the restriction setting 42 may identify (or otherwise refer to) “Casino 2” as being a second gaming entity 62 that is prevented from providing secondary offers 50 to the user. As a second example, a restriction setting 42 may provide a distance-based restriction (e.g., a restriction of 100 miles, 200 miles, 500 miles, or any other amount of distance between entities). In such an example, the restriction setting 42 may set an amount of distance from the first gaming entity 58 within which second gaming entities 62 may not provide secondary offers 50 to the user. Therefore, if the restriction setting 42 sets a distance of 50 miles, and Casino 2 is located within 50 miles of Casino 1, Casino 2 will be prevented from providing secondary offers 50 to the user. As a third example, a restriction setting 42 may provide a location-based restriction (e.g., a restriction on a particular street, city, state, country, etc.). In such an example, the restriction setting may set a location (such as, for example, the Las Vegas strip) from which second gaming entities 62 may not provide secondary offers 50 to the user. Therefore, if the restriction setting 42 sets a location of the Las Vegas strip, and Casino 2 is located on the Las Vegas strip, Casino 2 will be prevented from providing secondary offers 50 to the user. As a fourth example, a restriction setting 42 may provide a brick-and-mortar-based restriction (e.g., a restriction on brick-and-mortar casinos, as opposed to online casinos). In such an example, the restriction setting 42 may prevent any brick-and-mortar casino (such as, for example, a casino that includes a building that a customer can go to in order to play games) from providing secondary offers 50 to the user.

In particular embodiments, by providing one or more restriction settings 42, a first gaming entity 58 may prevent secondary offers 50 associated with one or more second entities 62 from being provided to a user associated with the first gaming entity 58. As such, the first gaming entity 58 may be able to prevent a competitor of the first gaming entity 58 from providing offers to the customers of first gaming entity 58. Furthermore, although particular types of restriction settings 42 have been described above, restriction settings 42 may include any other type of restriction, or any combination of the preceding.

Memory 38 may store any number and combination of restriction settings 42 for any number and combination of gaming entities.

Furthermore, although system 10 has been described above as including restriction settings 42, in particular embodiments, system 10 may additionally (or alternatively) include one or more allowances. An allowance represents any information that may provide one or more allowances associated with an entity. A first gaming entity 58 may want to allow another gaming entity (such as an out-of-market casino) to provide offers to users associated with the first gaming entity 58. In order to allow such offers, the first gaming entity 58 may provide (or otherwise be associated with) an allowance that allows other gaming entities to provide offers to the customers of first gaming entity 58.

An allowance may include any suitable number, combination, and types of allowances. As a first example, an allowance may provide an entity-specific allowance. In such an example, the allowance may identify (or otherwise refer to) “Casino 2” as being a second gaming entity 62 that is allowed to provide secondary offers 50 to the user. As a second example, an allowance may provide a distance-based allowance (e.g., an allowance of 100 miles, 200 miles, 500 miles, or any other amount of distance between entities). In such an example, the allowance may set an amount of distance from the first gaming entity 58 outside of which second gaming entities 62 may be allowed to provide secondary offers 50 to the user. Therefore, if the allowance sets a distance of 500 miles, and Casino 2 is located further than 500 miles from Casino 1, Casino 2 will be allowed to provide secondary offers 50 to the user. As a third example, an allowance may provide a location-based allowance (e.g., an allowance on a particular street, city, state, country, etc.). In such an example, the allowance may set a location (such as, for example, the Las Vegas strip) from which second gaming entities 62 may be allowed to provide secondary offers 50 to the user. Therefore, if the allowance sets a location of the Las Vegas strip, and Casino 2 is located on the Las Vegas strip, Casino 2 will be allowed to providing secondary offers 50 to the user. As a fourth example, an allowance may provide an online entity allowance (e.g., an allowance for online casinos, as opposed to brick-and-mortar casinos). In such an example, the allowance may allow any online casino to provide secondary offers 50 to the user.

Furthermore, although particular types of allowances have been described above, an allowance may include any other type of allowance, or any combination of the preceding. Additionally, although the following description is described with respect to restriction settings 42, any disclosure of a restriction setting 42 may additionally (or alternatively) refer to an allowance.

Second gaming entity information 46 represents any information regarding a second gaming entity 62. For example, as is illustrated, second gaming entity information 46 includes secondary offers 50. Secondary offers 50 represent one or more offers associated with the second gaming entity 62. The secondary offers of Casino 2 discussed above may be one example of secondary offers 50. Secondary offers 50 may be offers provided by the second gaming entity 62 in order to encourage a user associated with the first gaming entity 58 to visit and game at the second gaming entity 62.

A secondary offer 50 may be any type of offer associated with the second gaming entity 62. For example, a secondary offer 50 may be an offer for a discount (e.g., 10% off the next purchase), a gift (e.g., a free night of stay at the second gaming entity 62, a free ticket to a concert, $100 in chips at the second gaming entity 62, a free dinner, etc.), a status upgrade (e.g., an upgrade from no membership to a gold membership status), any other type of offer, or any combination of the preceding.

A secondary offer 50 may be associated with a range of values. For example, an offer for a free night of stay at the second gaming entity 62 may have a range of values that includes any value greater than $750, an offer for a free dinner may have a range of values that includes any value in-between $500 and $750, and an offer of $100 in player chips at the second gaming entity 62 may have a range of values that include any value in-between $200 and $499. The range of values associated with a secondary offer 50 may be determined in any suitable manner. For example, the range of values associated with a secondary offer 50 may be provided to device 14 by the second gaming entity 62, an administrator associated with device 14, a third-party entity, or any combination of the preceding. Furthermore, although the secondary offer 50 has been described above as being associated with a range of values, in particular embodiments, the secondary offer 50 may be associated with a single value (e.g., $750). Memory 38 may store any number and combination of secondary offers 50 for any number and combination of second gaming entities 62.

The primary offers 38, secondary offers 50, and restriction settings 42 stored by device 14 allow device 14 (e.g., a third party intermediary) to provide one or more of the secondary offers 50 to a user (e.g., Player 1) based on the value of one or more primary offer 38, as described above.

Network 54 represents any network operable to facilitate communication between the components of system 10, such as device 14, first gaming entity 58, second gaming entities 62, and user device 66. Network 54 may include any interconnecting system capable of transmitting audio, video, signals, data, messages, or any combination of the preceding. Network 54 may include all or a portion of a public switched telephone network (PSTN), a public or private data network, a LAN, a MAN, a WAN, a local, regional, or global communication or computer network, such as the Internet, a wireline or wireless network, an enterprise intranet, or any other communication link, including combinations thereof, operable to facilitate communication between the components.

First gaming entity 58 represents an entity that provides a product and/or service associated with gaming, gambling, and/or elements of chance. Casino 1 discussed above may be one example of a first gaming entity 58. First gaming entity 58 may be a casino, a racetrack, a sports betting service, a gaming service, any other entity that provides a product and/or service associated with gaming, gambling, and/or elements of chance, or any combination of the preceding. Furthermore, first gaming entity 58 may be a brick-and-mortar gaming entity (e.g., a casino that includes a building that a customer can go to in order to play games) and/or an online gaming entity (e.g., an online casino that a customer may access via a network, such as the Internet, in order to play games). Although the following description is described with respect to a first gaming entity 58 (and/or Casino 1), system 10 may be implemented with regard to any suitable first entity that provides a product and/or service, such as a bank, a supermarket, a store, a restaurant, a hotel, an airline, a car rental company, any other entity that provides a product and/or service, or any combination of the preceding.

First gaming entity 58 may communicate one or more primary offers 38 to device 14. For example, first gaming entity 58 may be associated with (or otherwise utilize) a device that may communicate primary offers 38 to device 14 (such as a personal computer, a work station, a laptop, a wireless or cellular telephone, an electronic notebook, a personal digital assistant, or any other device (wireless, wireline, or otherwise) capable of receiving, processing, storing, and/or communicating with other components of system 10). In such an example, an employee of first gaming entity 58 may utilize a computer in order to communicate primary offers 38 to device 14. As such, the first gaming entity 58 may be able to reward the user associated with the first gaming entity 58 (e.g., Player 1) for remaining loyal to the first gaming entity 58, and also may be able to entice Player 1 to continue playing games at the first gaming entity 58. Furthermore, although system 10 illustrates first gaming entity 58 as communicating primary offers 38 to device 14 (via primary offer message 100), in particular embodiments, any other entity may communicate primary offers 38 to device 14. For example, first gaming entity 58 may be associated with a third-party entity that communicates the primary offers 38 to device 14 for the first gaming entity 58.

Second gaming entity 62 represents an entity that provides a product and/or service associated with gaming, gambling, and/or elements of chance. Casino 2 discussed above may be one example of a second gaming entity 62. Second gaming entity 62 may be a casino, a racetrack, a sports betting service, a gaming service, any other entity that provides a product and/or service associated with gaming, gambling, and/or elements of chance, or any combination of the preceding. Furthermore, second gaming entity 62 may be a brick-and-mortar gaming entity (e.g., a casino that includes a building that a customer can go to in order to play games) and/or an online gaming entity (e.g., an online casino that a customer may access via a network, such as the Internet, in order to play games). Although the following description is described with respect to a second gaming entity 62 (and/or Casino 2), system 10 may be implemented with regard to any suitable second entity that provides a product and/or service in any suitable industry. As is illustrated, second gaming entity 62 is a different entity than first gaming entity 58. For example, second gaming entity 62 may be second casino (e.g., Casino 2) while first gaming entity 58 may be a first casino (e.g., Casino 1).

Second gaming entity 62 may communicate one or more secondary offers 50 to device 14. For example, second gaming entity 62 may be associated with (or otherwise utilize) a device that may communicate secondary offers 50 to device 14 (such as a personal computer, a work station, a laptop, a wireless or cellular telephone, an electronic notebook, a personal digital assistant, or any other device (wireless, wireline, or otherwise) capable of receiving, processing, storing, and/or communicating with other components of system 10). In such an example, an employee of second gaming entity 62 may utilize a computer in order to communicate secondary offers 50 to device 14. As such, the second gaming entity 62 may be able to entice Player 1 to play games at the second gaming entity 62. Furthermore, although system 10 illustrates second gaming entity 62 as communicating secondary offers 50 to device 14 (via secondary offer message 104), in particular embodiments, any other entity may communicate secondary offers 50 to device 14. For example, second gaming entity 62 may be associated with a third-party entity that communicates the secondary offers 50 to device 14 for the second gaming entity 62.

As is illustrated, system 10 may include more than one second gaming entity 62. System 10 may include any number and combination of second gaming entities 62. Furthermore, each second gaming entity 62 may represent a different entity. For example, one second gaming entity 62 may be a second casino (e.g., Casino 2) while another second gaming entity 62 may be a third casino (e.g., Casino 3) and another second gaming entity 62 may be a fourth casino (e.g., Casino 4).

User device 66 represents any components that allow a customer to view primary offer 38 and secondary offers 50. Player 1's smart phone discussed above may be one example of user device 66. User device 66 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10 in order to allow a user to view a secondary offer 50. In particular embodiments, user device 66 may further allow a user to request one or more secondary offers 50 for display, request one or more primary offers 38 for display, and/or allow the user to view the primary offers 38. User device 66 may comprise a user interface, such as a display, a microphone, keypad, or other appropriate terminal equipment usable by a user.

In order to perform one or more functions associated with system 10, user device 66 may execute an application 70. Application 70 represents any software or logic for receiving, generating, and/or communicating information to other components of system 10 in order to allow a customer to view secondary offers 50, view primary offers 38, request secondary offers 50 for display, and/or request primary offers 38 for display. The smart phone application (executed on Player 1's smart phone) discussed above may be one example of application 70. In one embodiment, Application 70 is associated with first gaming entity 58. For example, in order to allow a customer to view one or more primary offers 38 associated with first gaming entity 58, first gaming entity 58 may provide, or otherwise be associated with, application 70.

User device 66 may display a graphical user interface 74 in order to allow a customer to view secondary offers 50. Graphical user interface 74 may include any graphical interface that allows a customer to view secondary offers 50, view primary offers 38, request secondary offers 50 for display, and/or request primary offers 38 for display, among other functionality. For example, graphical user interface 74 may allow a customer to input one or more pieces of information in order to generate a request for one or more primary offers 38. The customer may input information in any manner. For example, the customer may type in the information using a keyboard on user device 66, may enter information using a touch screen, may select information from a pull/down list displayed on a graphical user interface 74, may input the information in any other manner, or any combination of the preceding. In particular embodiments, user device 66 may utilize application 70 to display graphical user interface 74.

In an exemplary embodiment of operation, a customer (e.g., Player 1) may join a loyalty program of the first gaming entity 58 (e.g., Casino 1, which may be a brick-and-mortar gaming entity and/or an online gaming entity) in order to receive primary offers 38 from Casino 1 (such as an offer for a free night of stay at Casino 1). These primary offers 38 may reward Player 1 for remaining loyal to Casino 1 and may further be used by Casino 1 to entice Player 1 to continue playing games at Casino 1 (as opposed to another casino). In order to provide one or more primary offers 38 to the customer, Casino 1 may communicate a primary offer message 100 to device 14 (e.g., a third party intermediary). In an attempt to entice Player 1 to play games at the second gaming entity 62 (e.g., Casino 2, which may be a brick-and-mortar gaming entity and/or an online gaming entity), Casino 2 may desire to provide one or more secondary offers 50 (e.g., a free night of stay at Casino 2, a free dinner, and/or $100 in player chips at Casino 2) to Player 1. As such, Casino 2 may communicate a secondary offer message 104 (which may include one or more of the secondary offers 50) to the third party intermediary.

Device 14 receives primary offer message 100 from the first gaming entity 58. Primary offer message 100 may include any information associated with one or more primary offers 38. As an example, primary offer message 100 may include the one or more primary offers 38. In such an example, when the first gaming entity 58 is offering a free night of stay at the first gaming entity 58 for a particular user (e.g., Player 1), the primary offer message 100 may include both the offer for a free night of stay and an indication that the offer is for Player 1.

As another example, the primary offer message 100 may include information that may allow device 14 to determine one or more primary offers 38. For example, the primary offer message 100 may include two separate files (e.g., comma separate value (CSV) files) that may allow device 14 to determine the one or more primary offers 38. The first file may be a player file that includes a list of customers who are loyalty program members of the first gaming entity 58. Each of the customers listed in the player file may be listed with one or more of: (1) a player number (e.g., the user's loyalty program membership number); (2) an alpha-numeric combination associated with the user (e.g., a zip code of the user or a birth date of the user); and (3) a status designation of the user (e.g., bronze membership status, silver membership status, gold membership status, platinum membership status, etc.). In particular embodiments, the player file may not include any identifying information associated with the customers. For example, the player file may not include the customer's name, the customer's address, the customer's contact information (e.g., phone number, e-mail address), or any other identifying information associated with the user. As such, the first gaming entity 58 may not have to disclose any identifying information for customers associated with the first gaming entity 58 to device 14 and/or second gaming entity 62.

The second file may be an offer file that includes any information associated with offers for a customer. For example, the offer file may include one or more of: (1) a summary of the offer (e.g., a “free night of stay”); (2) additional details regarding the offer (e.g., any information that further identifies the free night of stay, such as the type of room included in the offer); (3) validity dates associated with the offer (e.g., the offer is valid from Jan. 1, 2013 through Dec. 31, 2013); (4) an offer code associated with the offer (e.g., “free night”); (5) any other details associated with the offer; and (6) a status designation for the offer (e.g., bronze membership status, silver membership status, gold membership status, platinum membership status, etc.).

Based on the two separate files, device 14 may determine one or more primary offers 38. As an example, device 14 may utilize the status designations in both the player file and the offer file in order to determine one or more primary offers 38. In such an example, if Player 1 has a status designation of silver membership status, and the offer file includes an offer for a free night of stay at the first gaming entity 58 for users with a silver membership status, device 14 may determine that Player 1 should be given a primary offer 38 of a free night of stay at the first gaming entity 58. As such, the primary offer 38 of the free night of stay at the first gaming entity 58 may be communicated to the user, as is described herein.

Following the receipt of primary offer message 100, device 14 may determine a value associated with one or more of the primary offers 38. For example, device 14 may determine that a primary offer 38 of a “free night of stay” has a value of $500 and that a primary offer 38 for a “free ticket to a concert” has a value of $200. The value associated with a primary offer 38 may be determined in any suitable manner. For example, the value of the primary offer 38 may be provided to device 14 by the first gaming entity 58 (e.g., in primary offer message 100), an administrator associated with device 14, a third-party entity, or any combination of the preceding.

Device 14 further receives secondary offer message 104. Secondary offer message 104 may include any information associated with one or more secondary offers 50. As an example, secondary offer message 104 may include the one or more secondary offers 50. In such an example, when the second gaming entity 62 is offering a free night of stay at the second gaming entity 62, the secondary offer message 104 may include the offer for the free night of stay.

Based on the receipt (and/or storage) of primary offers 38 and secondary offers 50, device 14 may determine that at least one of the secondary offers 50 corresponds to a value associated with at least one of the primary offers 50. A secondary offer 50 may correspond to a primary offer 38 when a value associated with a primary offer 38 has a value that is in-between a range of values associated with the secondary offer 50 (e.g., the value of $500 is in-between the range of values of $500-$750), when a value associated with a primary offer 38 has the same value associated with the secondary offer 50 (e.g., the value of $500 is the same as $500), when a value associated with a secondary offer 50 is above (such as by a predetermined amount) a value associated with a primary offer 38 (e.g., the value of $750 is above the value of $700), and/or when a value associated with a secondary offer 50 is below (such as by a predetermined amount) a value associated with a primary offer 38 (e.g., the value of $700 is below the value of $750). In particular embodiments, device 14 may determine that at least one of the secondary offers 50 corresponds to a value associated with at least one of the primary offers 38 in order to determine which secondary offer 50 to provide to the customer. One reason for this is that in one embodiment neither device 14 nor second gaming entity 62 may know the status of Player 1 at the first gaming entity 58 (or identifying information for Player 1).

Device 14 may make this determination in any manner. As an example, device 14 may perform the following steps in order to determine that at least one of the primary offers 38 has an associated value that is in-between a range of values associated with a secondary offer 50.

First, device 14 may determine the range of values that are associated with a secondary offer 50. For example, device 14 may determine that: (1) a secondary offer 50 for a “free night of stay” at the second gaming entity 62 may be associated with a range of values that includes any value greater than $750; (2) a secondary offer 50 for a “free dinner” may be associated with a range of values that includes any value in-between $500 and $750; and (3) a secondary offer 50 for “$100 in player chips” at the second gaming entity 62 may be associated with a range of values that include any value in-between $200 and $499. The range of values associated with a secondary offer 50 may be determined in any suitable manner. For example, the range of values associated with a secondary offer 50 may be provided to device 14 by the second gaming entity 62 (e.g., in secondary offer message 104), an administrator associated with device 14, a third-party entity, or any combination of the preceding.

In one embodiment, device 14 may then determine which primary offer 38 has the highest value. For example, if a primary offer 38 of a “free night of stay” has a value of $500 and a primary offer 38 for a “free ticket to a concert” has a value of $200, device 14 may determine that the primary offer 38 of a “free night of stay” has the highest value (e.g., $500). Device 14 may utilize the primary offer 38 with the highest value so that the secondary offer 50 provided to the user may be an effective incentive to visit second gaming entity 62. For example, if the first gaming entity 58 provides a primary offer 38 worth $500 and another primary offer 38 worth $200, a secondary offer 50 that corresponds to only the $200 value may not be enticing to Player 1 when Player 1 has already been offered a primary offer 38 worth $500. In particular embodiments, determining which primary offer 38 has the highest value may refer to determining the value (e.g., $500) of the primary offer 38 that has the highest value.

Next, device 14 may determine which secondary offer 50 to communicate to a customer. In one embodiment, this determination may be performed by determining which secondary offer 50 is associated with a range of values that corresponds to the highest value of the primary offers 38 for the customer. Device 14 may make this determination by comparing the highest value of the primary offers 38 to the range of values associated with each of the secondary offers 50. For example, as is discussed above, the highest value of the primary offers 38 for a customer may be $500.Furthermore, as is also discussed above, the secondary offers 50 may include: (1) a secondary offer 50 for a “free night of stay” at the second gaming entity 62 that may be associated with a range of values that includes any value greater than $750; (2) a secondary offer 50 for a “free dinner” that may be associated with a range of values that includes any value in-between $500 and $750; and (3) a secondary offer 50 for “$100 in player chips” at the second gaming entity 62 that may be associated with a range of values that include any value in-between $200 and $499.

By comparing the highest value of the primary offers 38 to the range of values associated with each of the secondary offers 50, device 14 may determine that the range of values associated with the secondary offer 50 for a “free dinner” corresponds to the highest value of the primary offers 38 (e.g., the range of values in-between $500 and $750 corresponds to the highest value of $500). As such, device 14 may determine that the secondary offer 50 for a “free dinner” is to be communicated to the user. On the other hand, if the highest value of the primary offers 38 is $200, device 14 may determine that the range of values associated with the secondary offer 50 for “$100 in player chips” at the second gaming entity 62 corresponds to the highest value of the primary offers 38 (e.g., the range of values in-between $200 and $499 corresponds to the highest value of $200). As such, device 14 may determine that the secondary offer 50 for a “$100 in player chips” at the second gaming entity 62 is to be communicated to the user.

Although the above determinations have been described as being based on the highest value of the primary offers 38, the determinations may be based on any of the values of the primary offers 38. For example, the determinations may be based on the lowest value of the primary offers 38. In such an example, a secondary offer 50 may be provided to the customer when the secondary offer 50 corresponds to a primary offer 38 with the lowest value. As another example, the determination may be based on all (or a portion) of the primary offers 38. In such an example, if there are four primary offers 38, four secondary offers 50 may be provided to the customer. Furthermore, each of these four secondary offers 50 may correspond to one of the four primary offers 38. As another example, the determination may be based on an average of all (or a portion) of the primary offers 38. In such an example, a secondary offer 50 may be provided to the customer when the secondary offer 50 corresponds to an average of all of the values associated with four primary offers 38. In still other embodiments, a secondary offer 50 may be provided to the customer based on any suitable number, combination, and calculation of primary offer 38 over a time period.

Following the determination of which secondary offer 50 is to be communicated to a customer, device 14 may communicate the secondary offer 50 to user device 66 for display to the customer. The communication of the secondary offer 50 may be performed based on receiving a request message 108 from a customer. Request message 108 may include any type of request. For example, request message 108 may include a request for one or more primary offers 38 and/or one or more secondary offers 50. The customer may provide request message 108 in any suitable manner. For example, the customer may utilize graphical user interface 74 to input information associated with the request, such as the type of request (e.g., a request for only primary offers 38, a request for only secondary offers 50, a request for both primary offers 38 and secondary offers 50, a request for secondary offers 50 from second gaming entities 62 located in a particular region, such as Las Vegas, Nevada, etc.), any other information associated with the request, or any combination of the preceding.

Based on request message 108, device 14 may communicate results message 112 to user device 66. Results message 112 may include any information requested by the customer using request message 108. As an example, if the customer requests one or more primary offers 38 and one or more secondary offers 50, results message 112 may include the one or more primary offers 38 (e.g., the offer from the first gaming entity 58 of a “free night of stay” and the offer from the first gaming entity 58 of a “free ticket to a concert”) and may further include the secondary offer 50 that was determined based on one or more of the primary offers 38 (e.g., the offer from the second gaming entity 62 for “free dinner”). As such, the customer may be able to view that the first gaming entity 58 has offered the user a “free night of stay” and a “free ticket to a concert”, and may further be able to view that the second gaming entity 62 has offered the user a “free dinner”. Based on viewing these offers, the customer may select (or otherwise redeem) one or more of the primary offers 38 and/or the secondary offers 50.

Although device 14 has been described above as communicating results message 112 in response to receiving a request message 108 from user device 66, in particular embodiments, device 14 may communicate results message 112 without receiving a request message 108. As an example, device 14 may push results message 112 to user device 66 at suitable times. Additionally, device 14 may further receive, store, and communicate information associated with actions performed by a customer utilizing user device 66. For example, if device 14 has communicated one or more primary offers 38 (or one or more secondary offers 50) to user device 66, device 14 may receive and store information that indicates that the customer has viewed a particular offer, requested additional information about an offer, selected an offer, indicated that the user likes or dislikes an offer, performed any other action regarding primary offers 38 and secondary offers 50, or any combination of the preceding.

Furthermore, the primary offers 38 and the secondary offers 50 may be displayed to the customer on user device 66 in any suitable order. For example, the primary offers 38 may be displayed above (or before) the secondary offers 50. As another example, the display of a secondary offer 50 to the customer may be based on a status of a second gaming entity 62. For example, a secondary offer 50 from a second gaming entity 62 (e.g., Casino 2) may be displayed above (or before) a secondary offer 50 from a different second gaming entity 62 (e.g., Casino 3) when the Casino 2 has a higher status than Casino 3. In particular embodiments, the status of the second gaming entities 62 may be based on the number of users associated with each second gaming entity 62. For example, Casino 2 may have a higher status than Casino 3 when Casino 2 has more users associated with Casino 2 than does Casino 3.

Modifications, additions, or omissions may be made to system 10 without departing from the scope of the disclosure. For example, device 14 may receive any number and combination of primary offer messages 100, secondary offer messages 104, and/or request messages 108. Furthermore, device 14 may communicate any number of and combination results messages 112. Additionally, system 10 may include any number and combination of devices 14, networks 54, first gaming entities 58, second gaming entities 62, and/or user devices 66. Any suitable logic may perform the function of system 10 and codes within system 10.

Although system 10 has been described above as allowing a second gaming entity 62 to provide one or more secondary offers 50 to a customer associated with a first gaming entity 58, in particular embodiments, system 10 may also (or alternatively) allow the first gaming entity 58 to provide secondary offers to one or more customers associated with the second gaming entity 62 (or any other entity, such as a third gaming entity, a fourth gaming entity, etc.). As such, Casino 2 may provide offers to a customer associated with Casino 1 (e.g., such as a customer who is a member of Casino 1's loyalty program) using a smart phone application associated with Casino 1; and Casino 1 may also provide offers to a customer associated with Casino 2 (e.g., such as a customer who is a member of Casino 2's loyalty program) using a smart phone application associated with Casino 2. In such an example, both Casino 1 and Casino 2 may be able to provide meaningful offers to customers efficiently and effectively where they were previously unable to do so.

Additionally, although system 10 illustrates device 14 as communicating one or more secondary offers 50 associated with a second gaming entity 62 to user device 66 for display to a customer, in particular embodiments, device 14 may prevent one or more of such communications. For example, as is discussed above, the first gaming entity 58 may have provided one or more restriction settings 42 that may be associated with the second gaming entity 62 (or any other gaming entity). As such, if a restriction setting 42 is associated with (or otherwise applies to) a second gaming entity 62 (e.g., Casino 2 is located within 200 miles of the location of Casino 1), secondary offers 50 associated with that second gaming entity 62 may not be communicated to the user. However, if another gaming entity (such as Casino 3) is located more than 200 miles from Casino 1, Casino 3 may be able to provide offers to the user. Furthermore, in particular embodiments, if a first gaming entity 58 prevents a second gaming entity 62 from providing offers to a user associated with the first gaming entity 58, the first gaming entity 58 may also be prevented from providing offers to users associated with the second gaming entity 62.

Additionally, although device 14 of system 10 has been described above as performing one or more functions associated with receiving (and/or storing) one or more primary offers 38, receiving (and/or storing) one or more secondary offers 50, performing one or more determinations based on the primary offers 38 and secondary offers 50, and/or communicating one or more of the primary offers 38 and secondary offers 50 to the user device 66 for display to the customer, in particular embodiments, one or more (or all) of these functions may be performed by first gaming entity 58 or second gaming entities 62. For example, Casino 1 may make all (or a portion) of the determinations and communications associated with primary offers 38 and secondary offers 50. In such an example, Casino 2 may provide Casino 1 with one or more of the secondary offers 50. Furthermore, based on these received (and/or stored) secondary offers 50, Casino 1 may determine which secondary offers 50 should be provided to Player 1. In such an example, a third party intermediary (e.g., device 14) may not be utilized in system 10.

Furthermore, an example of system 10 is described above with respect to primary offers 38 and secondary offers 50 that are made to a single customer that is a loyalty program member of Casino 1. It should be understood that system 10 can be scaled to process primary offers 38 and secondary offers 50 for any number of customers that are loyalty program members of any number of casinos. Thus, for example, Casino 2 could make secondary offers 50 to any number and combination of customers of Casino 1 based on the value of primary offers 38 made by Casino 1 to each of these customers on an individual basis. Accordingly, a first customer of Casino 1 that maintains a high status with the loyalty rewards program of Casino 1 (e.g., platinum status) may receive better secondary offers 50 from Casino 2 than a second customer of Casino 1 that maintains a lower status with the loyalty rewards program of Casino 1 (e.g., bronze status). This is because the first customer would receive primary offers 38 from Casino 1 that have a higher value than the primary offers 38 received from Casino 1 by the second customer (e.g., free night of stay in a suite at Casino compared to a free dinner at Casino 1).

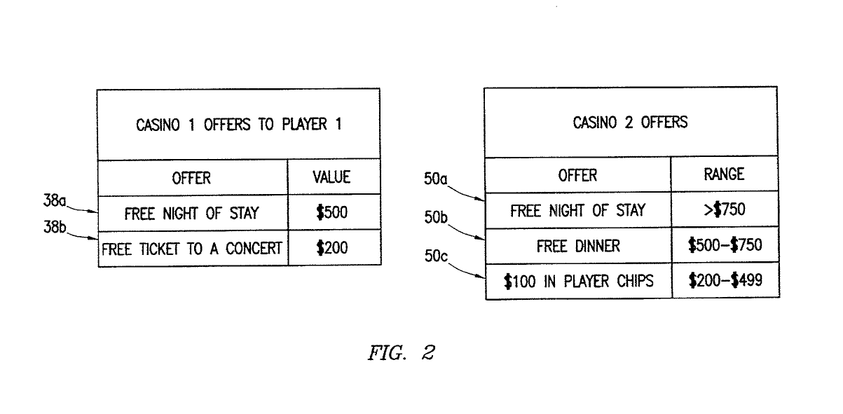

FIG. 2 illustrates examples of primary offers 38 associated with a first gaming entity 58 and secondary offers 50 associated with a second gaming entity 62. As is illustrated, primary offers 38 include a primary offer 38a for “free night of stay” (with an associated value of $500) and a primary offer 38b for a “free ticket to a concert” (with an associated value of $200). Each of these primary offers 38 are associated with a first gaming entity 58 (e.g., Casino 1), and are for a particular user (e.g., Player 1). Following the receipt (and/or storage) of these primary offers 38 by device 14 of FIG. 1, device 14 may communicate one or more of these primary offers 38 (for example, all of these primary offers 38) to user device 66 for display to the customer.

Secondary offers 50 include: (1) a secondary offer 50a for a “free night of stay” at the second gaming entity 62 (with an associated range of values that includes any value greater than $750); (2) a secondary offer 50b for a “free dinner” (with an associated range of values that includes any value in-between $500 and $750); and (3) a secondary offer 50c for “$100 in player chips” at the second gaming entity 62 (with an associated range of values that include any value in-between $200 and $499). Following the receipt (and/or storage) of these secondary offers 50 by device 14 of FIG. 1, device 14 may determine which of these secondary offers 50 is to be communicated to user device 66 for display to the customer. Such a determination may be triggered by the one or more primary offers 38. For example, as is discussed above, device 14 may determine which secondary offer 50 has an associated range of values that corresponds to a value (e.g., the highest value) of the one or more primary offers 38. In such an example, device 14 may determine that the range of values associated with the secondary offer 50 for a “free dinner” corresponds to the highest value of the primary offers 38 (e.g., the range of values in-between $500 and $750 corresponds to the highest value of $500). As such, device 14 may determine that the secondary offer 50 for a “free dinner” is to be communicated to the customer.

Modifications, additions, or omissions may be made to primary offers 38 and secondary offers 50 without departing from the scope of the disclosure. For example, primary offers 38 and/or secondary offers 50 may include more information, less information, and/or different information.

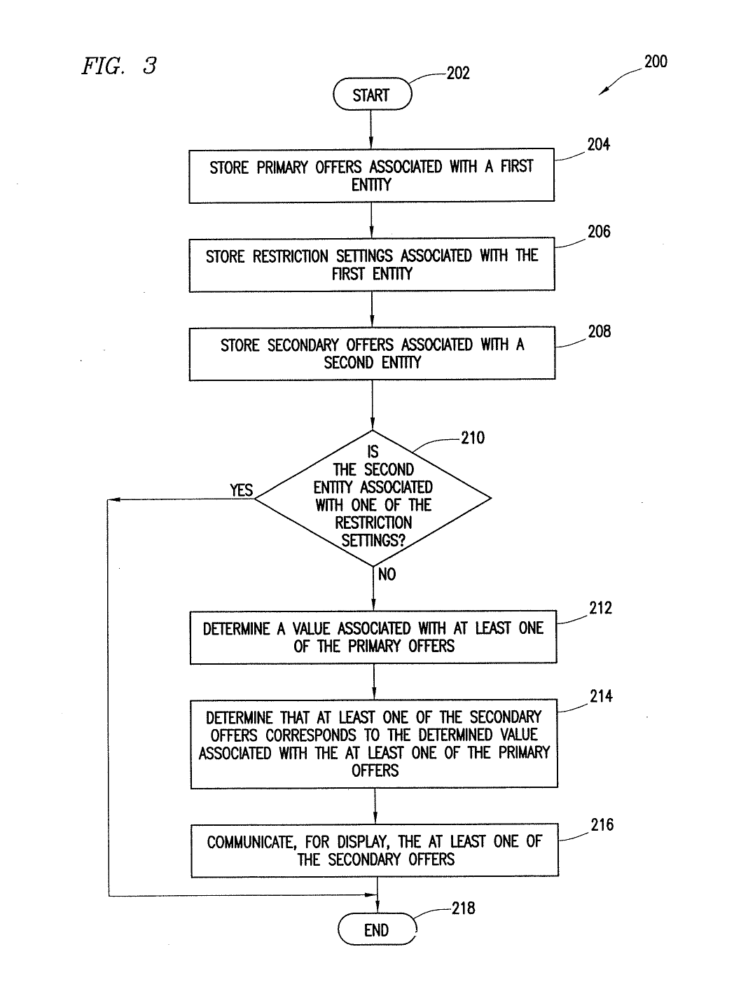

FIG. 3 illustrates a method 200 associated with a casino offer network. In particular embodiments, one or more steps of method 200 may be performed by device 14, first gaming entity 58, and/or second gaming entity 62 of FIG. 1.

The method begins at step 202. At step 204, one or more primary offers are stored. The primary offers may include any offer associated with a first entity, such as first gaming entity 58 of FIG. 1. As an example, the primary offers may be the primary offers 38 of FIG. 1. The primary offers may be stored after being received from a communication message, such as primary offer message 100 of FIG. 1. Furthermore, the primary offers may be stored after being input into a device, such as when an administrator (or other user) enters the primary offers into device 14 of FIG. 1.

At step 206, one or more restriction settings are stored. The restriction settings may include any information that may provide one or more restrictions. As an example, the restriction settings may be the restriction settings 42 of FIG. 1. The restriction settings may be stored after being received from a communication message, such as primary offer message 100 of FIG. 1. Furthermore, the restriction settings may be stored after being input into a device, such as when an administrator (or other user) enters the restriction settings into device 14 of FIG. 1.

At step 208, one or more secondary offers are stored. The secondary offers may include any offer associated with a second entity, such as second gaming entity 62 of FIG. 1. As an example, the secondary offers may be the secondary offers 50 of FIG. 1. The secondary offers may be stored after being received from a communication message, such as secondary offer message 104 of FIG. 1. Furthermore, the secondary offers may be stored after being input into a device, such as when an administrator (or other user) enters the secondary offers into device 14 of FIG. 1.

At step 210, it is determined whether the second entity (or any other entity, such as a third entity, a fourth entity, and so forth) is associated with one of the restriction settings. The second entity may be associated with one of the restriction settings when the restriction setting is applicable to the second entity. For example, a restriction setting may restrict any second entity within 200 miles of the first entity from providing secondary offers to a user associated with the first entity. In such an example, the second entity may be associated with the restriction setting when the second entity is located within 200 miles of the first entity. If the second entity is associated with one of the restriction settings, the method may move to step 218, where the method ends. On the other hand, if the second entity is not associated with one of the restriction settings, the method may move to step 212.

At step 212, a value associated with at least one of the primary offers is determined. As is discussed above with regard to FIG. 1, each primary offer 38 may be associated with a value. For example, an offer for a free night of stay at the first gaming entity 58 may be associated with the value of $500. The value may be determined in any suitable manner. For example, the value of the primary offer may be provided by the first gaming entity 58, an administrator associated with device 14, a third-party entity, or any combination of the preceding.

At step 214, it is determined that at least one of the secondary offers corresponds to the determined value associated with at least one of the primary offers. Such a determination may be performed in any suitable manner. For example, the determination may be performed by: (1) determining a range of values that are associated with the secondary offers; (2) determining which primary offer has the highest value; and (3) comparing the highest value of the primary offer to the range of values associated with each of the secondary offers. As an example, the highest value of the primary offers for a user may be $500. Furthermore, the secondary offers may include: (1) a secondary offer for a “free night of stay” at the second entity that may be associated with a range of values that includes any value greater than $750; (2) a secondary offer for a “free dinner” that may be associated with a range of values that includes any value in-between $500 and $750; and (3) a secondary offer for “$100 in player chips” at the second entity that may be associated with a range of values that include any value in-between $200 and $499. By comparing the highest value of the primary offers to the range of values associated with each of the secondary offers, it may be determined that the range of values associated with the secondary offer for a “free dinner” corresponds to the highest value of the primary offers (e.g., the range of values in-between $500 and $750 corresponds to the highest value of $500). As such, it may be determined that the secondary offer for a “free dinner” is associated with at least one of the primary offers.

At step 216, at least one of the secondary offers is communicated for display. For example, as is discussed above with regard to step 214, it may have been determined that the secondary offer for the “free dinner” is associated with at least one of the primary offers. In such an example, the secondary offer for a “free dinner” may be communicated for display to the user. The secondary offer may be displayed to the customer in any suitable manner. For example, the secondary offer may be displayed to the customer by a user device (such as user device 66 of FIG. 1) executing an application associated with the first entity (such as application 70 of FIG. 1). Following the communication of at least one of the secondary offers, the method may move to step 218, where the method ends.

Modifications, additions, or omissions may be made to method 200. For example, although method 200 is illustrated as ending at step 218, in particular embodiments, method 200 may include one or more additional steps. In such an example, method 200 may further include any of the steps or functionalities discussed above with regard to FIG. 1. Furthermore, in addition to (or as an alternative to) including steps for storing and utilizing restrictions settings, method 200 may include one or more steps for storing and utilizing one or more allowances. As another example, one or more steps of method 200 may not be performed. In such an example, one or more primary offers may not be stored. Instead, one or more values of the primary offer may be stored. As such, the one or more secondary offers may still be communicated based on a primary offer even if the primary offer is not stored. Furthermore, method 200 may not include any steps for storing and/or utilizing restriction settings (and/or allowances). Instead, any secondary offer may be allowed to be communicated (regardless of which entity the secondary offer is from) based on a primary offer. Additionally, one or more steps of method 200 may be performed in parallel or in any suitable order.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
a memory operable to:
store a first primary offer associated with a first gaming entity, the first primary offer associated with a first primary offer value;
store a second primary offer associated with the first gaming entity, the second primary offer associated with a second primary offer value;
store a first secondary offer associated with a second gaming entity, the first secondary offer associated with a first secondary offer value;
store a second secondary offer associated with the second gaming entity, the second secondary offer associated with a second secondary offer value;
store one or more restriction settings associated with the second entity; and
one or more processors communicatively coupled to the memory and operable to:
determine that the second entity is permitted to communicate secondary offers to program members of the first entity based at least in part upon the one or more restriction settings;
in response to determining that the second entity is permitted to communicate secondary offers to program members of the first entity, determine which of the first primary offer value and the second primary offer value is highest;
identify the one of the first secondary offer and the second secondary offer having a secondary offer value that is closest to the highest of the first primary offer value and the second primary offer value; and
communicate the identified secondary offer to a user device associated with at least one program member of the first entity.

2. A system, comprising:
a memory operable to:
store one or more primary offers associated with a first entity, each primary offer associated with a primary offer value; and
store a first secondary offer associated with a second entity, the first secondary offer associated with a first secondary offer value;
store a second secondary offer associated with the second entity, the second secondary offer associated with a second secondary offer value; and
one or more processors communicatively coupled to the memory and operable to:
compare the first secondary offer value and the second secondary offer value with the primary offer values of the one or more primary offers;
identify at least one of the first secondary offer and the second secondary offer based at least in part on the comparison; and
communicate the identified secondary offer to a user device.

3. The system of claim 2, wherein identifying comprises identifying the first secondary offer if its secondary offer value is closest to the primary offer value and identifying the second secondary offer if its secondary offer value is closest to the primary offer value.

4. The system of claim 2, wherein:
storing one or more primary offers comprises storing a first primary offer associated with a first primary offer value and storing a second primary offer associated with a second primary offer value; and
identifying comprises identifying the first secondary offer if its secondary offer value is closest to the highest primary offer value and identifying the second secondary offer if its secondary offer value is closest to the highest primary offer value.

5. The system of claim 2, wherein:
storing one or more primary offers comprises storing a first primary offer associated with a first primary offer value and storing a second primary offer associated with a second primary offer value; and
identifying comprises identifying the first secondary offer if its secondary offer value is closest to the average of the first primary offer value and the second primary offer value, and identifying the second secondary offer if its secondary offer value is closest to the average of the first primary offer value and the second primary offer value.

6. The system of claim 2, wherein:
storing one or more primary offers comprises storing a first primary offer associated with a first primary offer value and storing a second primary offer associated with a second primary offer value; and
identifying comprises identifying the first secondary offer if its secondary offer value is closest to a predetermined calculation of the first primary offer value and the second primary offer value, and identifying the second secondary offer if its secondary offer value is closest to the predetermined calculation of the first primary offer value and the second primary offer value.

7. The system of claim 2, wherein the one or more primary offers are associated with an individual that is a program member of the first entity and the user device is associated with the individual.

8. The system of claim 7, further comprising an application executing on the user device, the application operable to display the identifying secondary offer on the user device.

9. The system of claim 2, wherein:
the memory is further operable to store one or more restriction settings; and
the one or more processors is further operable to determine whether the one or more restriction settings forbids secondary offers associated with the second entity, wherein communicating the identifying secondary offer to the user device comprises communicating the identifying secondary offer to the user device only if the one or more restriction settings does not forbid secondary offers associated with the second entity.

10. The system of claim 2, wherein:
the memory is further operable to:
store at least one restriction setting that is based at least in part on a distance between the first entity and a third entity; and
store one or more secondary offers associated with the third entity; and
the one or more processors is further operable to communicate the secondary offer associated with the third entity to the user device only if the distance between the first entity and the third entity exceeds a predetermined threshold.

11. The system of claim 2, wherein:
the memory is further operable to:
store at least one restriction setting that is based at least in part on a location of a third entity; and
store one or more secondary offers associated with the third entity; and
the one or more processors is further operable to communicate the secondary offer associated with the third entity to the user device only if the location of the third entity is permitted.

12. The system of claim 2, wherein the memory and processor are associated with a third party intermediary that is separate from the first entity and the second entity.

13. The system of claim 2, wherein the memory and processor are associated with the first entity.

14. The system of claim 2, wherein the one or more processors are further operable to communicate the one or more primary offers to the user device.

15. The system of claim 2, wherein:
the memory is further operable to store a secondary offer associated with a third entity; and
the one or more processors are further operable to communicate the secondary offer associated with a third entity to the user device.

16. The system of claim 2, wherein:
the memory is further operable to:
store one or more primary offers associated with the second entity, each second entity primary offer associated with a primary offer value; and
store a first secondary offer associated with a first entity, the first secondary offer associated with a first secondary offer value;
store a second secondary offer associated with the first entity, the second secondary offer associated with a second secondary offer value; and
one or more processors communicatively coupled to the memory and operable to:
compare the first secondary offer value and the second secondary offer value associated with the first entity with the primary offer values of the one or more second entity primary offers;
identify at least one of the first secondary offer and the second secondary offer associated with the first entity based at least in part on the comparison; and
communicate the identified secondary offer associated with the first entity to a second user device that is associated with an individual that is a program member of the second entity.

17. The system of claim 7, wherein identifying information associated with the individual is not communicated to the second entity.

18. The system of claim 2, wherein the first entity comprises a first gaming entity and the second entity comprises a second gaming entity.

19. The system of claim 2, wherein the first entity comprises a first retail entity and the second entity comprises a second retail entity.

20. The system of claim 2, wherein:
the primary offers comprise first primary offers associated with a first program member of the first entity;
the memory is further operable to store second primary offers associated with a second program member of the first entity; and
the one or more processors is operable to communicate the identified secondary offer to the user device that is associated with the first program member and communicate one or more other secondary offers to a user device of the second program member.

21. A method, comprising:
storing one or more primary offers associated with a first entity, each primary offer associated with a primary offer value; and
storing a first secondary offer associated with a second entity, the first secondary offer associated with a first secondary offer value;
storing a second secondary offer associated with the second entity, the second secondary offer associated with a second secondary offer value;
comparing the first secondary offer value and the second secondary offer value with the primary offer values of the one or more primary offers;
identifying at least one of the first secondary offer and the second secondary offer based at least in part on the comparison; and
communicating the identified secondary offer to a user device.
